(19) United States
(12) Patent Application Publication
(10) Pub. No.: US 2010/0272384 A1
(43) Pub. Date: Oct. 28, 2010

(54) FORCE-MOMENT SENSOR

(76) Inventors: Mathias MUELLER, Muenchen (DE); Lars Hoffmann, Muenchen (DE); Tobias Lautenschlager, Groebenzell (DE); Alexander Koch, Muenchen (DE)

Correspondence Address: Muncy, Geissler, Olds & Lowe, PLLC, 4000 Legato Road, Suite 310, FAIRFAX, VA, 22033, US

(21) Appl. No.: 12/774,383

(22) Filed: May 5, 2010

Related U.S. Application Data
(63) Continuation of application No. PCT/EP2008/009318, filed on Nov. 5, 2008.

(30) Foreign Application Priority Data
Nov. 5, 2007 (EP) EP 07021502.5

(51) Int. Cl. G02B 6/00

(52) U.S. Cl. 385/13

(57) ABSTRACT

A force-moment sensor is provided for measuring at least one force and/or moment, which comprises a first part, a second part and an optical fibre arranged therebetween, said optical fibre comprising in at least one section a component for detecting deformations and/or stresses of the fibre transversely to its longitudinal axis. The present invention further relates to a method for measuring forces and/or moments. Thus, a fibre is provided which comprises at least one component for detecting deformations and/or stresses of the fibre transversely to a longitudinal axis of the fibre and into which light is introduced. According to this method, a force and/or moment acts on the fibre, wherein at least one component of the force and/or moment acts perpendicularly to the longitudinal axis of the fibre. The light reflected in the fibre is then detected and the detected spectrum analysed.

This nonprovisional application is a continuation of International Application No. PCT/EP2008/009318, which was filed on Nov. 5, 2008, and which claims priority to EP Patent Application No. 07021502.5, which was filed on Nov. 5, 2007, and which are both herein incorporated by reference.

### BACKGROUND OF THE INVENTION

1. Field of the Invention

The invention relates to a force-moment sensor for measuring forces and/or moments by using an optical fibre as well as to a respective method for measuring forces and/or moments.

2. Description of the Background Art

Sensors which can measure forces and/or moments are used in a wide variety of technical fields. Such sensors usually can detect the magnitude and direction of the applied force as well as of the moment at a fixing point. It becomes increasingly important to be able to dimension such sensors as small and lightweight as possible in order to ensure an application as flexible as possible. In many technical fields, in particular in component monitoring, stress analysis, robotics and bionics, but also, for example, in medical engineering, both precise and miniaturized sensors are indispensible.

Typically, force-moment sensors are realized by mechanical structures which convert applied forces and moments into strains in the structure, which can then be detected, for example, by means of so-called strain gauges. Such strain gauges often use the effect that the electrical resistance of specific semiconductors or constantan foils depends on their state of strain. Piezoelectric and capacitance methods are also used.

In order to be able to measure forces and moments in three directions orthogonal to each other, a respective three-dimensional geometric structure is required. A known structure is, for example, the so-called Stewart platform, which is described as an exemplary embodiment using strain gauges in DE 102 17 018 A1.

It is further known that so-called fibre Bragg gratings can also be used for strain measurement. Fibre Bragg gratings are also referred to as optical “substitute” for strain gauges. To this end, light is coupled into an optical fibre which is provided with fibre Bragg gratings in one or more places. The optical interference effect within the optical fibre is usually achieved in that the refractive index of the fibre core is periodically modulated in the area of the fibre Bragg grating. It is readily understandable that tensile strain of the fibre along the optical axis entails that the period of this refractive index modulation is varied. Consequently, the spectrum of the reflected light gives information about the extent of tensile or compressive strain of the fibre at the place of the fibre Bragg grating. Furthermore, several fibre Bragg gratings can be easily integrated into one optical fibre. To this end, the (unextended) modulation periods of the individual gratings are preferably differently selected. It is thus possible to assign specific spectral ranges to corresponding gratings and thus corresponding positions within the fibre, i.e. the sensor. The sensors are or the fibre is preferably spectrally encoded so that the sensor signals, i.e. the light reflected at the individual gratings, do not overlap. It is thus possible to easily separate the signals of the individual gratings from each other and to evaluate them.

The use of fibre Bragg gratings in a multi-component force sensor is described, for example, in A. Fernandez-Fernandez et al., “Multi-component force sensor based on multiplexed fibre Bragg grating strain sensors”; Measurement Science and Technology 12, 1-4 (2001).

Irrespective of the use of the respective mechanical, electrical or optical effects, however, it is a problem of conventional sensors that the described three-dimensional structure of, for example, the Stewart platform requires a certain dimension, in particular height, which can hardly be undercut. In particular, the known attachment or use of the strain sensors requires that the direction of measurement of at least one of these sensors proportionately points in the direction of each force/moment to be measured, which entails a disadvantageous cubic expansion of the sensor. Moreover, the rigidity of known sensors is limited for reasons inherent in the sensor structure. Besides, the design of such sensors, for example of a Stewart platform, requires exceptionally precise machining of metal components. This renders the design and production of such sensors complex and expensive.

### SUMMARY OF THE INVENTION

It is therefore an object of the present invention to provide an improved force-moment sensor for measuring forces and/or moments which at least partly overcomes or minimizes the aforementioned disadvantages. This object is achieved by a sensor comprising the features of the independent claims. In the dependent claims, preferred embodiments of the sensor according to the invention are described.

Accordingly, for the determination of the force and/or moment components by means of optical fibres, the present invention is based in particular on the idea of using the deformation or strain of the optical fibre along a transverse direction, i.e. perpendicular to the fibre axis. It is thus possible to arrange, for example, sensor components in one plane essentially two-dimensionally, whereby, i.a., the size of the sensor in one dimension and/or its rigidity can be significantly reduced.

The present invention provides a force-moment sensor for measuring at least one force and/or moment, which comprises a first part and a second part and an optical fibre arranged therebetween, said optical fibre comprising in at least one section a component for detecting deformations and/or stresses of the fibre transversely to its longitudinal axis.

Preferably, the component for detecting deformations of the optical fibre is adapted to measure forces and/or moments being orthogonal to each other or their components transversely to the longitudinal axis of the fibre and independently of each other. A fibre Bragg grating, for example, in which an optical interference effect within the optical fibre is achieved in that the refractive index of the fibre core is periodically modulated during the production, is suitable for this purpose. The period of this modulation can be varied not only by subjecting the fibre to tensile or compressive strain along its optical axis or length, as described above, but it can also be manipulated by transverse deformations, i.e. perpendicular to its longitudinal axis. In the case of transverse strains, however, the period is primarily modified in that this strain entails a modification of the refractive index, wherein the spatial period preferably is not modified. The refractive index is influenced by transverse strains and then produces a polarisation dependence.

Such transverse deformations can be compression, shearing, tensile strain, compressive strain, or the like. They are generally also referred to as strains. Moreover, stresses may also have an influence on the optical properties, e.g., the refractive index, which likewise entails a variation of the modulation period. Consequently, the state of deformation or stress of the optical fibre in the respective section can be inferred, for example, from a spectral analysis of the reflected light.

On the one hand, the deformation or strain measurement preferably is based on the change in the period at the section of, for example, the fibre Bragg grating, which can be imagined to be a crystal lattice along the fibre axis. When the fibre stretches, the grating stretches as well. The wavelength of the reflected light changes as a function of the grating spacing. A second preferred effect is the change in the refractive index of the material from which the fibre is made. When the material is stretched, the refractivity or the refractive index changes, which entails a change in the wavelength in the material and thereby in the “optical period” of the grating.

When a fibre Bragg grating is subjected to tensile strain that is transverse to the fibre axis, the grating period is preferably changed only by the transverse strain of the material. Additionally, there is a change in the refractivity. However, since the refractivity that the light experiences is additionally also dependent on, for example, the direction of the polarisation of the light, conclusions with respect to the strain direction and its magnitude can preferably be drawn from the evaluation of the polarisation of the light together with the spectrum.

Preferably, an optical fibre with inscribed fibre Bragg gratings as strain sensors is used. In this connection, the fibre Bragg gratings preferably are not subjected to strain along the axis of the fibre as usual, which is the case when used as a conventional strain sensor, but the strain is preferably determined transversely to the fibre axis. Besides, it is preferably not only the transverse strain in one direction that is determined but preferably the direction of the transverse strain components by means of an evaluation of the polarisation of the light reflected by the fibre Bragg grating is determined as well.

It is thus in particular possible to avoid that the sensor axis must also be aligned with the respective force axes. Hence, the minimum height of the previous force-moment sensor designs can be undercut. Furthermore, this type of structure increases the rigidity of the sensors.

Preferably, a polarisation-maintaining fibre with fibre Bragg gratings is used in order to be able to better distinguish between the two polarisation directions. This fibre preferably only serves the purpose of controlling the polarisation of the light up to the site of the sensor and back again.

In order to ensure the appropriate transmission of the forces and/or moments acting on the sensor to the optical fibre, the section comprising the component for detecting deformations is mechanically connected with the first and second parts in such a way that forces or moments acting on the first part and/or the second part of the sensor lead to measurable deformations transversely to the longitudinal axis of the fibre in this section of the fibre. This section of the optical fibre, for example, can be glued to the first and second parts. Other attachment methods and/or means are also possible, wherein, however, it is advantageous when the attachment enables the transmission of pressure forces and tensile forces in the same manner.

In order to convert the forces and/or moments into stresses in the fibre, an attachment or arrangement is preferred that entails that two forces perpendicular to each other lead to two different strains or stresses in the fibre.

In an embodiment, the optical fibre comprises in at least one further section, particularly preferably in two further sections, one further component (each) for detecting deformation(s) and/or stress(es) of the fibre transversely to its longitudinal axis. This enables in particular the measurement of force components and/or moment components in several spatial directions. To this end, it is necessary that at least two of the fibre sections are arranged such that their longitudinal axes enclose an angle, wherein a great angle is preferred for a sufficient resolution. For example, angles of at least 45°, preferably of about 60° and particularly preferably of about 90° are provided. Preferably, the longitudinal axes of the sections are arranged in one plane.

Optionally, the sensor further comprises a light source and an appropriate optical detector. Preferably the light source emits a relatively large spectral range, in particular white light. Light-emitting diodes, superluminescent diodes or tunable lasers, for example, can be used for this purpose. The detector is preferably adapted to perform a spectral analysis, i.e. to detect the intensities of different wavelengths. Spectrometers or Fabry-Perot interferometers are appropriate, for example.

When several sections comprising components for sensing deformations are provided within the same fibre, it is advantageous to configure the individual components such that they generate signals having different signatures even in the non-deformed, i.e. initial or original state, for example in that different spectral ranges are reflected. The light coming from a fibre and detected by a detector can thus be assigned to the individual measurement sections within the fibre according to its signature. A first section, for example, could reflect light in the blue spectral range and a second section could reflect light in the green spectral range. Deformations in the first region would then lead to signal variations in the blue light, deformations in the second region to variations in the green light.

It is further preferred that the first and/or second part of the sensor, in the area of the section(s) comprising the one or more components for detecting the deformations and/or stresses, comprises a transverse strain generating structure (preferably each) which is configured such that forces and/or moments acting on the first and/or second part of the sensor lead to measurable deformations transversely to the longitudinal axis of the fibre in this section of the fibre. This transverse strain generating structure preferably exhibits an offset. Furthermore, it is advantageous that the transverse strain generating structures are arranged on alternate sides of the sections and/or have an alternate symmetry.

The present invention further relates to a method of measuring forces and/or moments. Accordingly, a fibre is provided which comprises at least one component for detecting deformations and/or stresses of the fibre transversely to a longitudinal axis of the fibre and into which light is introduced. According to the method, a force and/or moment acts on the fibre, wherein at least one component of the force and/or the moment acts perpendicularly to the longitudinal axis of the fibre. The light reflected in the fibre is then detected and the detected spectrum analysed. In this method, the component for detecting deformations and/or stresses of the fibre preferably comprises a fibre Bragg grating.

The method is preferably configured such that forces or moments being orthogonal to each other can be measured transversely to the longitudinal axis of the fibre and independently of each other.

In a further embodiment of the method, it is further possible to measure three force and/or moment components being essentially perpendicular to each other by arranging several components for detecting deformations and/or stresses in one plane.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a section through a part of a preferred embodiment of the sensor according to the invention;

FIG. 2 shows a schematic top view on a part of a preferred sensor according to the invention comprising an optical fibre and four components;

FIG. 3 shows a schematic top view on a part of a further preferred sensor according to the invention comprising an optical fibre and four components;

FIG. 4 shows a perspective view of the part illustrated in FIG. 3;

FIG. 5 shows a perspective view of a sensor according to the invention depicting a first and a second part as well as an optical fibre of the sensor;

FIG. 6 shows a perspective view of a first part of an alternative embodiment of the sensor according to the invention;

FIG. 7 shows a side view of the first part from FIG. 6 together with the corresponding second part; and

FIG. 8 shows a detail view of the first part from FIG. 6.

### DETAILED DESCRIPTION

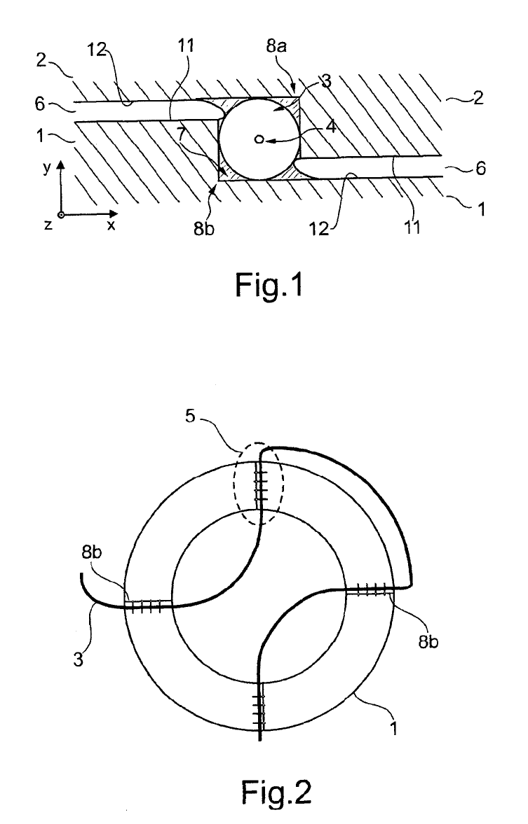

FIG. 1 illustrates a schematic section through a part of a preferred embodiment of the sensor according to the invention. An optical fibre 3 with a fibre core 4 is arranged between a first and a second part or carrier part 1 and 2 comprising a carrier material of a sensor according to the invention and preferably embedded therebetween. Apparent requirements for the carrier material are robustness, mechanical rigidity and easy machinability. Accordingly, the fabrication from, for example, a metal or metal alloy or a hard plastic material would be advantageous. Brass, steel or ceramics are preferred.

The fibre 3 can be mechanically connected to the two parts 1 and 2 of the sensor by means of an attachment 7. The attachment 7 can include, for example, that the fibre 3 is cast into a respective recess or groove within the parts 1 and 2. In this connection, the use of an appropriate adhesive, e.g. epoxy resins, is also advantageous. Since in particular a high modulus of elasticity is necessary, soldering pewter or similar solders, for example, are also suitable, whose modulus of elasticity is typically about ten times as high as the one of corresponding adhesives. However, the attachment 7 may also comprise an elastic material so that the optical fibre 3 can be clamped or pressed between the two parts 1 and 2. Preferably, a thin bore is used as a guide for the optical fibre.

The invention is based, i.a., on the idea that transverse stresses can be measured in the transverse direction, i.e., in the case of FIG. 1 in the direction of the x- and y-axes, and preferably distinguished from each other. To this end, it may be advantageous to provide an appropriate structure and/or arrangement of the (carrier) parts 1, 2 in addition to the described embedding of the fibre 3. In the embodiment shown in FIG. 1, for example, a gap 6 between the first and second parts exhibits an offset at the position of the fibre 3. This offset is adapted to introduce the acting forces in a well-directed manner into the fibre 3 and thus to convert them into specific or desired stress patterns within the fibre. The fact that forces along the x- and the y-axes (as shown in FIG. 1) lead to stresses or deformations of the fibre 3 which can be distinguished from each other can in particular be ensured by an appropriate position and/or shape of the gap(s) 6. Transverse strains as well as shearing strains are coupled into the fibre by the step structure illustrated in FIG. 1. A force in the y direction, for example, generates a compressive strain of the fibre in the y direction, but an extension in the x direction due to the transversal contraction. The same is analogously true for a force in the x direction. Since the transverse strain condition in the fibre core can be reconstructed via the evaluation of the polarisation, the direction of transverse force and its quantity can be determined as well. Furthermore, a further direction of force or moments can be determined by combining several such structures. Alternatively, an integrated optical structure of the sensor is preferred. To this end, the waveguide is directly applied to a substrate. The introduction of force is then back-calculated via shearing strains or stresses. The waveguide guidance preferably corresponds in this connection to the one depicted in FIG. 2. In this case, the edge structure can be dispensed with. As mentioned above, the introduced strains are in this case partly shearing strains which are also optically evaluated.

Alternatively and/or additionally, the transverse strain generating structure shown in FIG. 1, i.e., a structure which is adapted to introduce the acting forces in a well-directed manner into the fibre 3 and thus to convert them into specific or desired measurable stress patterns within the fibre, is preferably configured such that each of the first part 1 and the second part 2 of the sensor comprise one or more edges or steps 8a, 8b. In this case, as indicated in FIG. 1, the two parts 1 and 2 are arranged on each other or connected with each other such that essentially two corresponding edges 8a and 8b provide a space or cavity for accommodating the fibre 3. Preferably, the two parts 1 and 2 are arranged such that there is at least partly a contact-free area 6. On account of the arrangement of the two edges 8a and 8b, this contact-free area preferably exhibits an offset or a step. Preferably, the parts 1 and 2 therefore comprise matched or correspondingly designed sides which are adapted to accommodate between them at least one fibre 3 with at least one section comprising component 5. To this end, the respective surfaces of the parts 1 and 2 comprise matched contours or geometries.

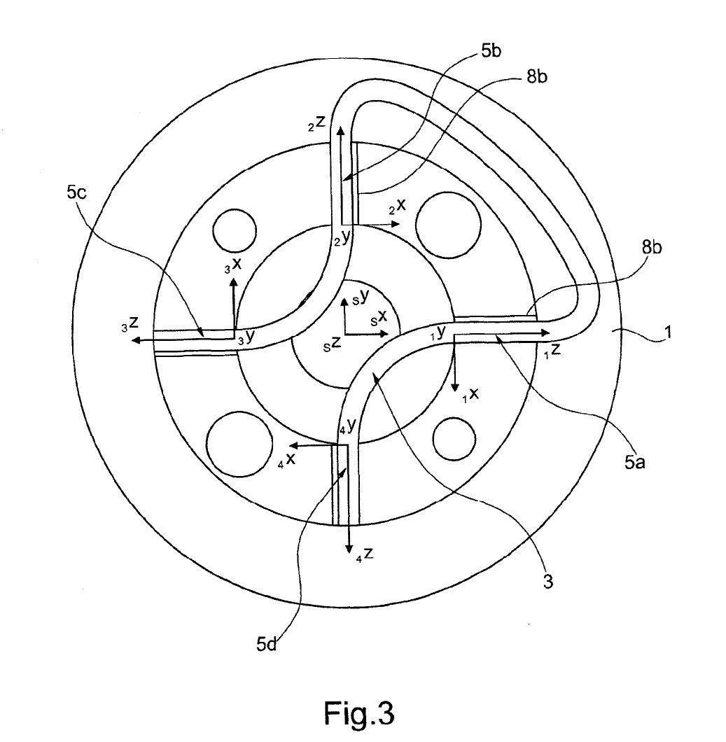

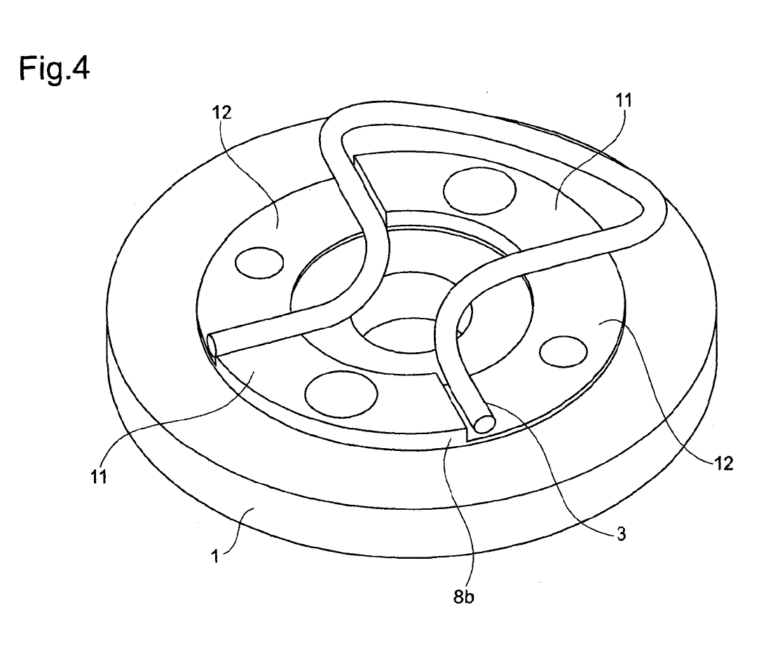

FIGS. 2 and 3 illustrate a schematic top view on a preferred first part 1 of a sensor according to the invention together with an optical fibre 3 and four components 5 or rather 5a, 5b, 5c and 5d for detecting deformations and/or stresses, here preferably fibre Bragg gratings. The respective second part 2 of the sensor is not illustrated. Since one component for detecting deformations and/or stresses or fibre Bragg grating can detect two strain components and since there is generally interest in a total of six independent parameters, the sensor should comprise at least three components for detecting deformations and/or stresses or fibre Bragg gratings. Further component for detecting deformations and/or stresses or gratings, like a fourth component in the example of FIGS. 2 and 3, can increase the precision of the measurement. Preferably by means of a fourth grating, it is, for example, possible to compensate for a temperature or temperature gradient within the structure. For specific applications, however, it may also be desired to renounce the measurement of certain components. In this case, the sensor comprises only one or two components for detecting deformations and/or stresses or gratings.

In the following, reference is only made to the preferred use of fibre Bragg gratings as the component for detecting deformations and/or stresses. However, it is self-evident that also other appropriate means are preferably used.

It will be clear to the person skilled in the art that, when three fibre Bragg gratings are used, the gratings must be arranged such that force or moment components can be measured in all three spatial directions. To this end, for example, an arrangement on two axes perpendicular or essentially perpendicular to each other is advantageous, as illustrated in FIGS. 2 and 3. In the case of only three gratings, for example, a symmetrical arrangement with 120° between the gratings is conceivable. As already mentioned above, the axis perpendicular to the plane of projection (FIGS. 2, 3) does not have to be used since every grating provides two measuring directions, one of which advantageously points perpendicularly to the plane of projection. The fibres or the sections of the fibre(s) comprising the component for detecting deformations and/or stresses are preferably arranged so that their longitudinal axes are aligned to each other in an essentially radial direction. Preferably the fibre(s) or the sections are arranged essentially in one plane.

Corresponding to the arrangement of the fibre Bragg gratings or the component for detecting deformations and/or stresses, the respective transverse strain generating structures, i.e., for example the edges 6 are preferably provided according to this arrangement in the two parts 1 and 2. In the preferred embodiment depicted in FIG. 2, the edges 8b of the first part 1 are arranged on respectively alternate sides of the fibre sections. This applies analogously to the edges 8a of the second part. In other words, the transverse strain generating structures preferably comprise an alternate symmetry.

A further embodiment of the edges is illustrated in FIG. 3. The corresponding perspective illustration depicted in FIG. 4 shows the three-dimensional structure of the edges 8b even more clearly.

It should be understood that not only the arrangement of the gratings and/or transverse strain component but also the entire geometric configuration of the embodiments illustrated in FIGS. 2 and 3 is to be regarded as an example. A rectangular, square, triangular or any other basic structure is also conceivable. The guidance of the optical fibre 3 can also be adapted as desired without deviating from the invention. An embodiment comprising several fibres and/or a three-dimensional arrangement of the gratings is also preferred.

Conventional, commercially available optical fibres can be used as the fibre. Depending on the respective arrangement, it may be advantageous that the fibre used comprises a small admissible radius of curvature. It is furthermore expedient to use a polarisation-maintaining fibre to facilitate the evaluation of the detected signal. Fibres whose optical properties considerably change under deformation or stress, for example polymer fibres or polymer-based fibres, are particularly suitable, as well as in particular sapphire fibres for applications with high temperatures.

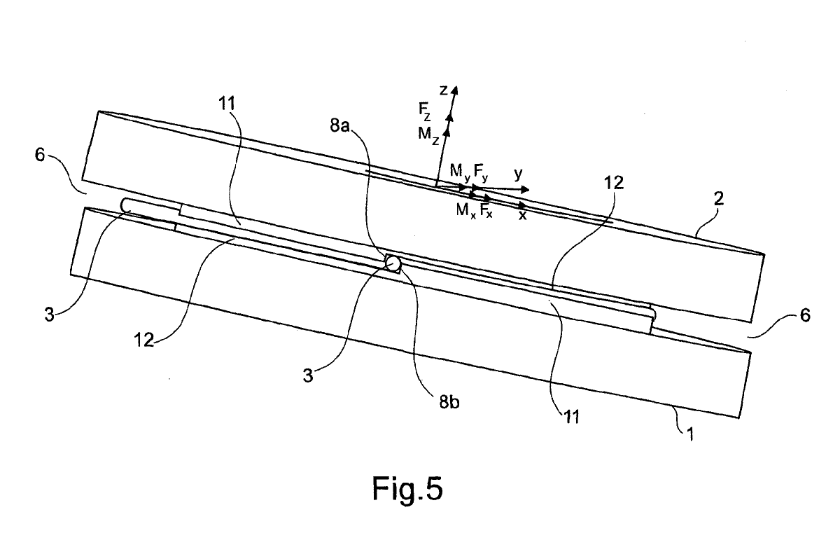

In FIG. 5, a preferred, readily assembled sensor according to the invention is shown, in which the first part 1 and the second part 2 firmly enclose the optical fibre 3 at least in the sections. In a preferred embodiment, both parts are connected to each other essentially only via the optical fibre 3 or the connection or attachment material 7 surrounding it, while apart from that the two parts are separated from each other via a gap 6, for example the one shown in FIG. 1 or FIG. 5. It is thus ensured that all forces or moments occurring between the two parts are transmitted to the optical fibre 3 and lead to corresponding deformations or stresses there.

Alternatively, however, it is also possible that the two parts comprise additional connection elements to achieve, for example, a greater stability. However, these connection elements should preferably be elastic so that at least part of the occurring forces or moments is transmitted to the optical fibre despite these connections.

In the preferred embodiment according to FIGS. 2 and 3, part 1, and preferably correspondingly also part 2 (not illustrated), comprises four transverse strain generating structures 8 which are preferably arranged in a way offset from each other by 90° and furthermore preferably are arranged approximately in one plane. Thus, each two transverse strain generating structures 8 (8a, 8b) are spaced apart from each other and aligned in the same direction along the fibre. Preferably, each two of the transverse strain generating structures 8 (8a, 8b) aligned in essentially the same direction along the fibre are arranged on different or opposite sides of the fibre. Preferably, the four transverse strain generating structures 8 offset from each other by 90° are alternately arranged on the respective other side of the fibre 3 when seen clockwise or anticlockwise.

The outer sides of the parts 1 and 2 optionally comprise additional attachment elements for the respective application. For example, threads, bores, pegs, grooves, flanges or similar means may be provided in order to connect or attach the sensor according to the invention to further appliances or devices. As described above, the sensor may, of course, comprise additionally a light source (not shown) and a corresponding detector. Furthermore, a control unit, for example an accordingly programmed PC, may be provided which controls the individual components and evaluates the detected signals, i.e., calculates the forces and/or moments from the measured spectrum.

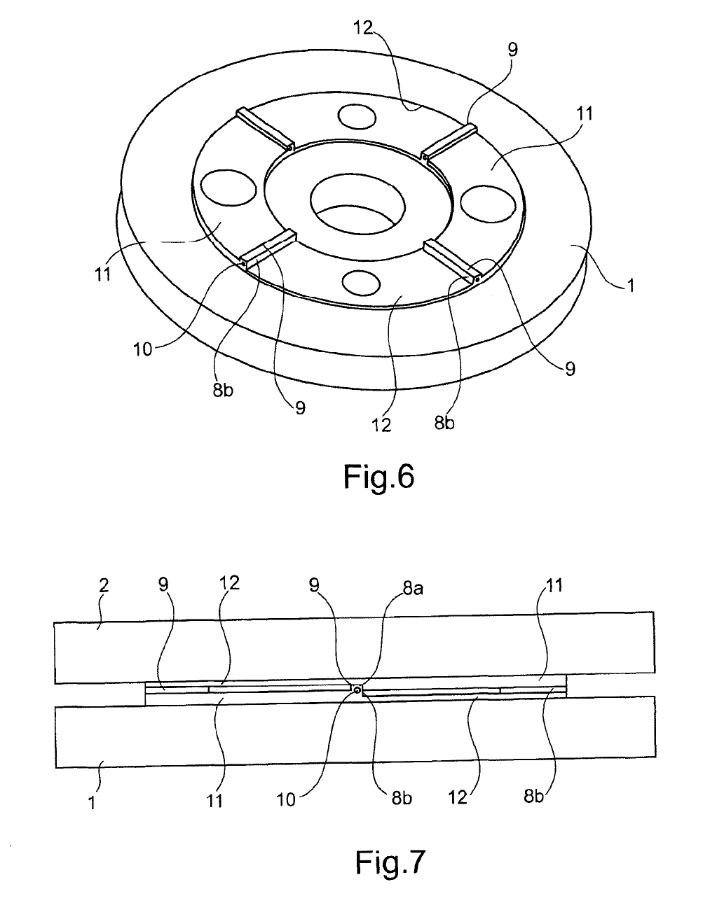

FIG. 6 shows a perspective view of a first part of a further preferred embodiment of the sensor according to the invention. In this embodiment, the above described transverse strain generating structure 8 comprises ribs or ridges 9 each of which comprises a guide bore or opening 10 into which the optical fibre 3 can be introduced. FIG. 7 shows a side view of a respective sensor having first and second parts.

In this Figure, it can be seen particularly clearly that an offset or edge 8b is provided preferably in the area of the rib or ridge 9. Similarly to the above discussed embodiment, the second part 2 of the sensor preferably comprises corresponding edges 8a which in engagement with the ribs 9 form a transverse strain generating structure. Preferably, the configuration of the edges 8a and 8b in this preferred embodiment corresponds to that of the above described embodiment, wherein the space or cavity formed by two corresponding edges is filled by the rib or ridge 9 for accommodating the fibre 3.

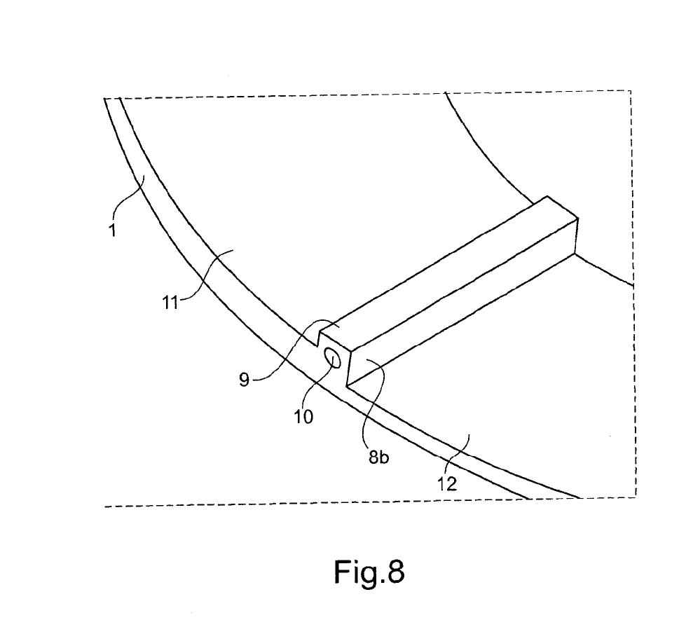

As can be seen, i.a., in FIG. 4, the part 1 preferably comprises a raised area 11 which forms an edge 8b relative to a deepened or recessed area 12. Preferably, raised areas 11 and areas 12 recessed relative thereto are alternately arranged approximately circularly so that a raised area 11 together with two recessed areas 12 form two edges 8b and wherein a recessed area 12 together with two raised areas 11 form two edges 8b. This design is also preferably realized in the embodiment according to FIGS. 1 to 7, as apparent from the Figures. In the area of the edges, i.e., at the transition from a raised area 11 to a recessed area 12, a rib 9 is formed in the embodiment according to FIGS. 6 to 8. This can also be deduced from the detail view according to FIG. 8.

In a preferred embodiment, the fibre having a small diameter of preferably about 70 to 90 μm and more preferably about 80 μm is first copper-plated with a copper sheath having a thickness of preferably about 40 to 60 μm and more preferably 50 μm. Subsequently, the copper-plated fibre is threaded into the gaps or the guide bores, heated and soldered with the guide hole by adding soldering pewter. A sensor according to the invention preferably has a diameter of about 10 to 30 mm and more preferably of about 20 mm.

The sensor according to the invention has several advantages over conventional sensors. On the one hand, it can be relatively easily and cost-efficiently produced with standard methods already known. Its design is simple and robust as compared to conventional sensors. It can be configured, for example, considerably more rigidly than sensors already known. Nevertheless, it enables measurements of great precision. Its small size and/or two-dimensional realization is a particular advantage: Since the individual sensor elements can be arranged in one plane and at the same time configured relatively thinly, a sensor is provided which has a considerably reduced size in one dimension in comparison to conventional sensors. Nevertheless, the sensor according to the invention can detect forces and moments perpendicularly to its two-dimensional shape. A clear extension of the spatial arrangement in the direction of the force to be measured is in particular not necessary. Thus, the sensor according to the invention can be flexibly used and is suitable for specific applications with high miniaturization requirements.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A force-moment sensor for measuring at least one force and/or moment, the sensor comprising:
a first part;
a second part; and
an optical fibre arranged between the first part and the second part, the optical fibre having a longitudinal axis,
wherein said optical fibre comprises, in at least one section, a component for detecting deformations and/or stresses of the optical fibre transversely to the longitudinal axis.

2. The sensor according to claim 1, wherein said component for detecting deformations and/or stresses of the optical fibre is adapted to measure forces or moments being orthogonal to each other, transversely to the longitudinal axis of the optical fibre, and independently of each other.

3. The sensor according to claim 1, wherein the component for detecting deformations and/or stresses of the optical fibre comprises a fibre Bragg grating.

4. The sensor according to claim 1, wherein the section comprising the component for detecting deformations and/or stresses at least partly is mechanically connectable with the first and second parts such that forces or moments acting on the first part and/or the second part of the sensor lead to measurable deformations transversely to the longitudinal axis of the optical fibre in this section of the optical fibre.

5. The sensor according to claim 1, wherein the optical fibre further comprises, in at least one further section, an additional component for detecting deformations and/or stresses of the fibre transversely to the longitudinal axis.

6. The sensor according to claim 1, wherein the optical fibre further comprises, in two, three, four or more sections, additional components for detecting deformations and/or stresses of the optical fibre transversely to the longitudinal axis.

7. The sensor according to claim 5, wherein at least two of the optical fibre sections are arranged such that their longitudinal axes enclose an angle of at least 60°.

8. The sensor according to claim 7, wherein at least two of the optical fibre sections are arranged such that their longitudinal axes are orthogonal to each other.

9. The sensor according to claim 5, wherein the optical fibre sections are arranged such that their longitudinal axes are in one plane.

10. The sensor according to claim 1, wherein the optical fibre is polarisation-maintaining.

11. The sensor according to claim 1, wherein the sensor further comprises a light source and an optical detector.

12. The sensor according to claim 5, wherein the component for detecting deformations and/or stresses are adapted to generate signals having different signatures.

13. The sensor according to claim 1, wherein the first and/or second part, in the area of the section(s) comprising the one or more components for detecting deformations and/or stresses, comprises a transverse strain generating structure that is configured such that forces and/or moments acting on the first and/or second part of the sensor lead to measurable deformations transversely to the longitudinal axis of the optical fibre in this section of the optical fibre.

14. The sensor according to claim 13, wherein the transverse strain generating structure exhibits an offset.

15. The sensor according to claim 13, wherein the transverse strain generating structures are arranged on alternate sides of the sections and/or have an alternate symmetry.

16. The sensor according to claim 13, wherein the transverse strain generating structures comprise ribs.

17. A method for measuring forces and/or moments, the method comprising:
providing a fibre comprising at least one component for detecting deformations and/or stresses of the optical fibre transversely to a longitudinal axis of the fibre;
introducing or coupling light into the fibre;
upon a force and/or moment acting on the fibre, at least one component of the force and/or moment acts in a direction substantially perpendicular to the longitudinal axis of the fibre;
detecting the light reflected in the fibre; and
analyzing a detected spectrum.

18. The method according to claim 17, wherein the component for detecting deformations and/or stresses of the fibre comprises a fibre Bragg grating.

19. The method according to claim 17, wherein the forces or moments that are orthogonal to each other, are measured transversely to the longitudinal axis of the fibre and independently of each other.

20. The method according to claim 17, wherein three forces and/or moments that are substantially perpendicular to each other are measured by arranging in one plane several components for detecting deformations and/or stresses.
